(19) United States
(12) Patent Application Publication
(10) Pub. No.: US 2024/0233294 A1
(43) Pub. Date: Jul. 11, 2024

(54) TOPOLOGICAL PRESERVING DEFORMATION METHOD FOR 3D MODEL BASED ON MULTIPLE VOLUMETRIC HARMONIC FIELD

(71) Applicant: DALIAN UNIVERSITY OF TECHNOLOGY, Dalian, Liaoning (CN)

(72) Inventors: Shengfa WANG, Dalian, Liaoning (CN); Yiming ZHU, Dalian, Liaoning (CN); Xiaopeng ZHENG, Dalian, Liaoning (CN); Na LEI, Dalian, Liaoning (CN); Zhongxuan LUO, Dalian, Liaoning (CN); Fuwei CHEN, Dalian, Liaoning (CN); Yongjie WANG, Dalian, Liaoning (CN); Fan ZHANG, Dalian, Liaoning (CN)

(21) Appl. No.: 17/778,263

(22) PCT Filed: May 8, 2021
(86) PCT No.: PCT/CN2021/092249

§ 371 Date: Nov. 17, 2022

(51) Int. Cl. G06T 19/20; G06T 17/20

(52) U.S. Cl. CPC G06T 19/20; G06T 17/20; G06T 2219/2021

(57) ABSTRACT

The present invention discloses a topological preserving deformation method for a 3D model based on a multiple volumetric harmonic field, and belongs to the fields of computer graphics, computational mathematics, topology and differential geometry. Firstly, a tetrahedral mesh is constructed between a source 3D model and a target 3D model; then, a domain of topological transformation in a deformation process is calculated based on a traditional single volumetric harmonic field; special multiple boundary conditions are set; next, a multiple volumetric harmonic field is calculated; and finally, topological preserving surface deformation is induced. The present invention can find the domain of topological transformation in the deformation process based on a saddle point in the traditional volumetric harmonic field, and can adaptively construct the multiple volumetric harmonic field that can induce topological preserving deformation, so as to generate topological preserving deformation surfaces under the guidance of the multiple volumetric harmonic field. The method has universality and high efficiency for 3D model deformation of the same topology, requires less computational cost compared with the traditional large deformation diffeomorphism metric mapping, and can be widely used.

### TECHNICAL FIELD

The present invention belongs to the fields of computer graphics, computational mathematics, topology and differential geometry, and relates to a method for constructing three-dimensional diffeomorphism mapping based on a multiple volumetric harmonic field, applicable to low genus surfaces with complex geometry. In the method, the multiple volumetric harmonic field is used as a guided field to calculate an anisotropic volumetric harmonic field so as to construct three-dimensional diffeomorphism mapping.

### BACKGROUND

In a two-dimensional case, the harmonic mapping of two convex plane domains is diffeomorphism if and only if the boundary condition is diffeomorphism. However, it is difficult to construct diffeomorphism mapping in a three-dimensional case. At present, the only universal method is large deformation diffeomorphism metric mapping (LDDMM), but its computational cost is very expensive. The diffeomorphism mapping plays an important role in the fields of computer graphics, medical image analysis and finite element mesh generation. Three-dimensional diffeomorphism mapping can induce topological preserving surface deformation in space, which is a powerful tool for the generation of a boundary layer mesh required in computational fluid mechanics, so as to solve the mesh generation at concave and cavity features which cannot be used by traditional methods.

### SUMMARY

Based on the above problems, the present invention proposes a method for constructing three-dimensional diffeomorphism mapping based on a multiple volumetric harmonic field, including four invention contents:
1. generation of a tetrahedral discrete mesh of a deformation space between 3D models:
2. construction of a multiple volumetric harmonic field:
3. generation of an anisotropic scalar field guided by the multiple volumetric harmonic field:
4. topological preserving deformation of the 3D model based on the anisotropic scalar field.

The technical solution of the present invention is as follows:
1. Generation of a tetrahedral discrete mesh of a diffeomorphism deformation space between a source model and an envelope model
1) Inputting a source 3D model and an envelope 3D model with the same topology as the source 3D model, and generally using a triangular surface mesh or a quadrilateral surface mesh;
2) Defining the deformation space of the 3D model as a space between the source 3D model and the envelope 3D model:
3) Discretizing the deformation space by using the tetrahedral mesh. If four vertexes of a tetrahedral mesh element are all on the source 3D model or the envelope 3D model, then segmenting the tetrahedral mesh element and circulating until there is no such situation;
4) tessellating the mesh of the deformation space according to model features. Firstly, calculating a scalar field in the tetrahedral mesh by using a Laplace operator, and calculating the position of a saddle point (singularity) in the scalar field. Then, tessellating tetrahedral elements near the saddle point (singularity) to improve the local mesh resolution. Finally, optimizing the tetrahedral mesh after local tessellation to improve the quality of mesh elements.
2. Construction of a multiple volumetric harmonic field
1) Defining the multiple volumetric harmonic field on the vertex of the tetrahedral mesh:

$$H ( {v}_{p} ) = [ {H}_{I} ( {v}_{p} ) , {H}_{2} ( {v}_{p} ) , … , {H}_{d} ( {v}_{p} ) ] , \qquad ( 1 )$$

where d is a multiple index of the multiple volumetric harmonic field, and Hᵢ(νₚ) is a scalar value obtained by an i-th multiple volumetric harmonic field acting on the vertex νₚ of the tetrahedral mesh, i=1, 2, . . . d.
2) Calculating the definition of a Laplace equation of the multiple volumetric harmonic field on the tetrahedral grid:

$$LG = 0 , \qquad ( 2 )$$

where L is a weight matrix for solving the Laplace equation, with an expression:

$${L}_{pq} = \{ \begin{matrix}{\sum }_{{v}_{k} ∈ N ( {v}_{p} )} w ( {e}_{pq} ) , & p = q ; \\ - w ( {e}_{pq} ) , & {v}_{q} ∈ N ( {v}_{p} ) \\ 0 , & other ;\end{matrix} ; \qquad ( 3 )$$

where e_{pq} is an edge on the tetrahedral mesh and has endpoints of νₚ and respectively; N(νₚ) is a neighbor region point set of νₚ; and G is a multiple volumetric harmonic field matrix which has an expression:

$$G = [ \begin{matrix}{H}_{1} ( {v}_{1} ) & {H}_{2} ( {v}_{1} ) & … & {H}_{d} ( {v}_{1} ) \\ {H}_{1} ( {v}_{2} ) & {H}_{2} ( {v}_{2} ) & … & {H}_{d} ( {v}_{2} ) \\ ⋮ & ⋮ & ⋱ & ⋮ \\ {H}_{1} ( {v}_{n} ) & {H}_{2} ( {v}_{n} ) & … & {H}_{d} ( {v}_{n} )\end{matrix} ] ; \qquad ( 4 )$$

w(e_{pq}) is the edge weight of calculating the Laplace equation, which is a classical cotangent weight, with an expression:

$$w ( {e}_{pq} ) = \frac{1}{12} {\sum }_{N ( {e}_{pq} )} {l}_{ij} cot ( {θ}_{ij} ) , \qquad ( 5 )$$

where N(e_{pq}) is a neighbor region of a tetrahedral mesh element of e_{pq}; lᵢⱼ and θᵢⱼ where pq and are the side length of eᵢⱼ and a dihedral angle about eᵢⱼ in the tetrahedral mesh element respectively; and eᵢⱼ is an edge which connects the other two vertexes except νₚ and ν_{q} in the tetrahedral mesh element.

3) Calculating the multiple volumetric harmonic field on the tetrahedral mesh:
Defining multiple volumetric harmonic energy

$$T ( H ) = {\sum }_{{e}_{pq} ∈ E} w ( {e}_{pq} ) {( {‖ H ( {v}_{p} ) - H ( {v}_{q} ) ‖}_{∞} )}^{2} , \qquad ( 6 )$$

where E is an edge set on the tetrahedral mesh.

Converting the calculation of the multiple volumetric harmonic field on the tetrahedral mesh into the optimization of the multiple volumetric harmonic energy T(H); when T(H) is minimized, H is the multiple volumetric harmonic field.

The present invention optimizes the multiple volumetric harmonic energy T(H) by an iteration method, with an iteration formula:

$$H ( {v}_{p} ) = \frac{{\sum }_{{v}_{q} ∈ N ( {v}_{p} )} w ( {e}_{pq} ) H ( {v}_{q} )}{{\sum }_{{v}_{q} ∈ N ( {v}_{p} )} w ( {e}_{pq} )} , \qquad ( 7 )$$

Steps of iterative computation of the multiple volumetric harmonic field are as follows:

setting d-multiple Dirichlet boundary condition H(vₗ)=C on the source 3D model and the envelope model, where Vi is a control point and C is a d dimensional constant: setting the maximum iteration number of optimizing the multiple volumetric harmonic energy as Kᵢₜₑᵣ (generally 2000), and an energy optimization truncation threshold as t_{energy} (generally 1e-6): based on formula (7), iteratively updating the values of the multiple volumetric harmonic field acting on the vertexes of the tetrahedral mesh until the energy truncation threshold t_{energy} or the maximum iteration number kᵢₜₑᵣ is satisfied.

4) Constructing boundary conditions of the multiple volumetric harmonic field for inducing topological preserving deformation of the 3D model:
a. constructing a single volumetric harmonic field for the deformation space. setting the energy of the source 3D model as a scalar constant X (generally 1), and the energy of the target 3D model as a scalar constant y (generally 0), and calculating the single volumetric harmonic field on the tetrahedral mesh:
b. calculating the saddle point (singularity) in the single volumetric harmonic field (scalar field), denoted by S={S₁, S₂, . . . Sₙ}. The saddle point (singularity) provides the position of topological change of the source 3D model when induced by the volumetric harmonic field and deformed to a target 3D model. If no saddle point (singularity) exists in the single volumetric harmonic field (scalar field), there is topological preserving deformation that can directly induce the source 3D model to the target 3D model based on isosurfaces:
c. extracting boundary constraint points of the multiple volumetric harmonic field. Detecting more than two feature points or feature domains on the model according to the saddle points along a harmonic field gradient. tracing to the 3D model along a gradient line from the saddle point (singularity) Sᵢ in the single volumetric harmonic field, and generally tracing to at least two vertexes or two domains, denoted by

$${R}^{{s}_{i}} = \{ {r}_{1}^{{s}_{i}} , {r}_{2}^{{s}_{i}} , … , {r}_{m}^{{s}_{i}} \} ;$$

d. according to the extracted feature point (domain) pairs, using each feature point pair as the corresponding Dirichlet boundary condition to construct the volumetric harmonic field of the corresponding multiple indexes (the number of the feature point pairs). If n saddle points (singularities) exist in the single volumetric harmonic field (scalar i tracing field), and each saddle point (singularity) respectively corresponds to m vertexes or domains, constructing

$${\sum }_{i = 1}^{n} {m}_{i}$$

multiple volumetric harmonic field; setting the Dirichlet boundary condition of j-th multiple volumetric harmonic field H^{s}^{ᵢ}ⱼ corresponding to as: sᵢ

$${H}_{j}^{{S}_{i}} ( {v}_{k} ) = \{ \begin{matrix}α , & {v}_{k} ∈ {r}_{j}^{{S}_{i}} ; \\ β , & {v}_{k} ∈ {R}_{j}^{{S}_{i}} \backslash {r}_{j}^{{S}_{i}} ;\end{matrix} \qquad ( 8 )$$

where α is generally 1, and β is generally 0.

3. Generation of an anisotropic scalar field guided by the multiple volumetric harmonic field, specifically as follows:

1) Calculating anisotropic edge weight based on the multiple volumetric harmonic field:

$$\overline{w} ( {e}_{pq} ) = 1. / exp ( {‖ H ( {v}_{p} ) - H ( {v}_{q} ) ‖}_{2} * λ , \qquad ( 9 )$$

where λ is a parameter for controlling the influence degree of the multiple volumetric harmonic field on the edge weight (λ is generally 10): the smaller λ is, the less the influence of the edge weight w(e_{pq}) by the multiple volumetric harmonic field H is; the larger λ is, the more the influence of the edge weight w(e_{pq}) by the multiple volumetric harmonic field H.

2) Calculating the scalar fields based on the anisotropic edge weight:

$$\overline{L} F = 0 , \qquad ( 10 )$$

where F is the anisotropic scalar field acting on the tetrahedral mesh and L is a weighted Laplace matrix, with an expression:

$${\overline{L}}_{pq} = \{ \begin{matrix}{\sum }_{{v}_{k} ∈ N ( {v}_{p} )} \overline{w} ( {e}_{pq} ) , & p = q ; \\ - \overline{w} ( {e}_{pq} ) , & {v}_{q} ∈ N ( {v}_{p} ) ; \\ 0 , & other ;\end{matrix} \qquad ( 11 )$$

3) Setting the Dirichlet boundary conditions:

$$F ( {v}_{k} ) = \{ \begin{matrix}γ , & {v}_{k} ∈ {M}_{source} \\ χ , & {v}_{k} ∈ {M}_{target}\end{matrix} ; \qquad ( 12 )$$

where y and X are constant scalars (Y is generally 1, and X is generally 0): M_{source} and M_{target} are the source 3D model and the target 3D model respectively.

4. Topological preserving deformation of the 3D model based on the anisotropic scalar field
1) Extracting n parts of isosurfaces from the anisotropic scalar field, denoted as g={g₁, g₂, . . . , gₙ}: each isosurface is a state of a deformation process.
2) Starting from a point νₖ ∈M_{source} on the source model, tracing to n parts of isosurfaces along the gradient of the anisotropic scalar field to obtain n new vertexes {vₖ¹, vₖ², . . . , vₖⁿ} respectively.
3) According to the obtained vertex vₖⁱ on each layer, generating n parts of topological preserving deformation models {M₁, M₂, . . . , Mₙ} by using M_{source} based vertex connection mode.

Beneficial effects of the present invention: the topological preserving deformation method for the 3D model based on the multiple volumetric harmonic field proposed by the present invention can construct three-dimensional diffeomorphism mapping and induce a family of topological preserving deformation surfaces. In traditional surface deformation, if the source surface contains concave or slit features, topological transformation often occurs in the deformation process, which is illegal in some specific applications, such as boundary layer mesh generation. Therefore, it is very meaningful and challenging to find a family of topological preserving deformation surfaces between the source 3D model and the target 3D model. The present invention can find the domain of topological transformation in the deformation process based on the saddle point in the traditional volumetric harmonic field, and can adaptively construct the multiple volumetric harmonic field that can induce topological preserving deformation, so as to generate topological preserving deformation surfaces under the guidance of the multiple volumetric harmonic field. The method has universality and high efficiency for 3D model deformation of the same topology, requires less computational cost compared with the traditional large deformation diffeomorphism metric mapping (LDDMM), and can be more widely used.

### DESCRIPTION OF DRAWINGS

FIG. 1 is a flow chart of an algorithm of the present invention:

FIG. 2 shows a source dual-contact 3D model:

FIG. 3 is a target cubic 3D model;

FIG. 4 shows a saddle point and a tracing domain of a volumetric harmonic field of a deformation space:

FIG. 5 shows surface deformation induced by a traditional volumetric harmonic field; and

FIG. 6 shows topological preserving deformation of surfaces induced by a multiple volumetric harmonic field.

### DETAILED DESCRIPTION

Specific embodiments of the present invention are further described in detail below in combination with the drawings and the technical solution.

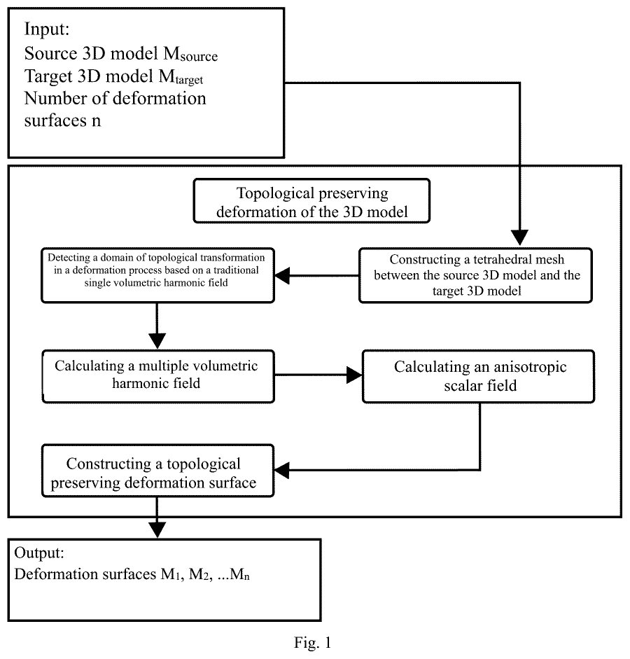

The algorithm execution process of the present invention includes five calculation steps, as shown in FIG. 1:
1) constructing a tetrahedral mesh between a source 3D model and a target 3D model:
2) detecting a domain of topological transformation in a deformation process based on a traditional single volumetric harmonic field:
3) setting special multiple boundary conditions based on a saddle point of the traditional single volumetric harmonic field, and calculating a multiple volumetric harmonic field:
4) calculating an anisotropic scalar field based on the multiple volumetric harmonic field:
5) constructing topological preserving deformation surfaces in the deformation space based on the anisotropic scalar field.

The algorithm input of the present invention:
1) a source 3D model (generally a triangular surface mesh or a quadrangular surface mesh):
2) a target 3D model (generally a triangular surface mesh or a quadrangular surface mesh);
3) deformation times n.

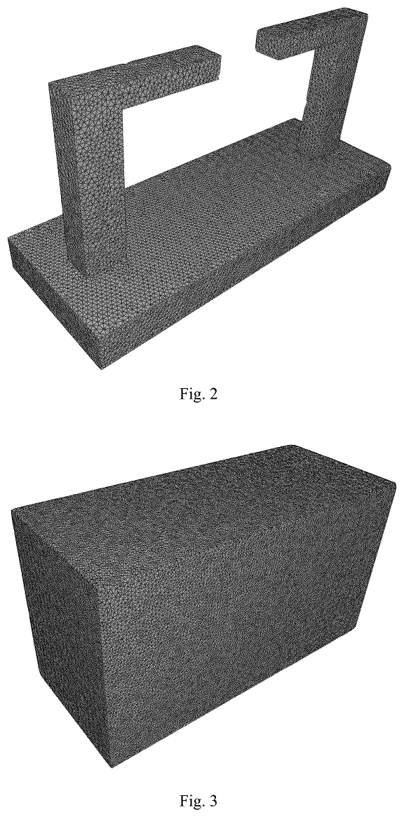

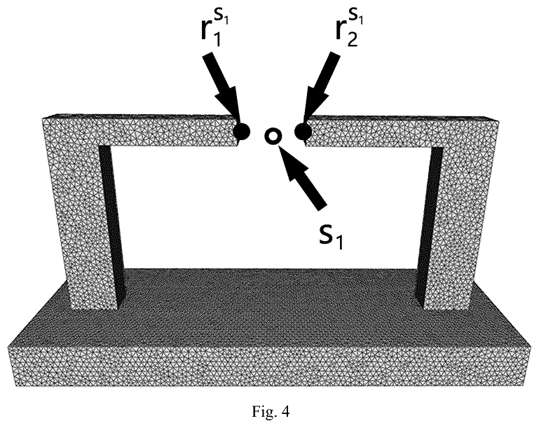

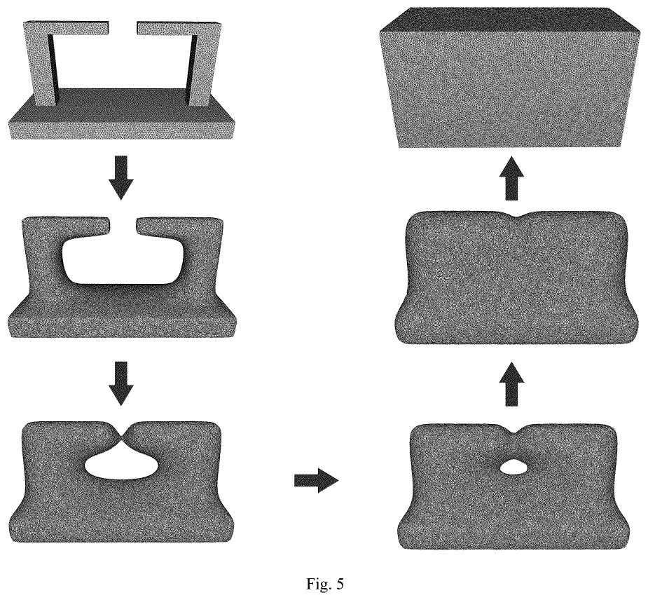

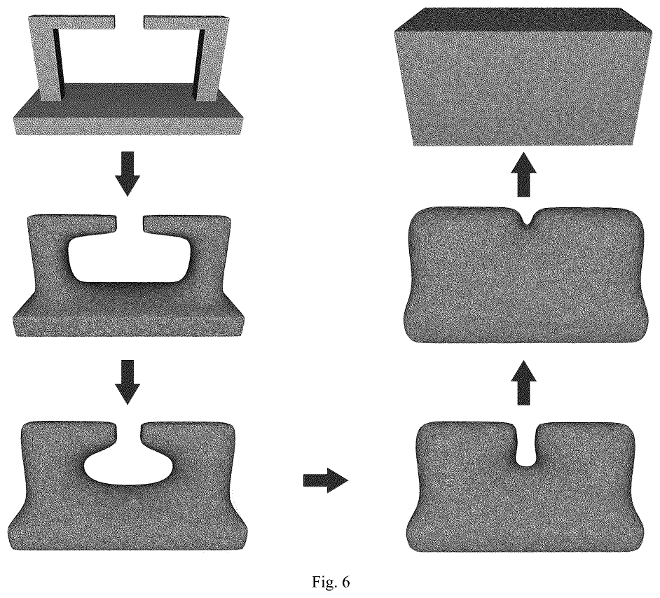

The implementation case of the present invention takes topological preserving deformation of a dual-contact 3D model to a cubic 3D model as an example. At present, based on the existing method, it is difficult to calculate the topological preserving deformation of the dual-contact 3D model to the cubic 3D model in 3D space, as shown in FIG. 5, so this example has illustrative value. The method based on the multiple volumetric harmonic field in the present invention can be well applied to such model and has expansibility, as shown in FIG. 6. The specific implementation steps are as follows:
1. inputting the dual-contact triangular surface mesh as the source 3D model, as shown in FIG. 2; inputting the cubic triangular surface mesh as the target 3D model, as shown in FIG. 3: inputting deformation times of 4:
2. filling a tetrahedral mesh between the source 3D model and the target 3D model by using Tetgen tetrahedral mesh generation software:
3. setting the vertex energy of the source 3D model as 1, and the vertex energy of the target 3D model as 0 to serve as boundary conditions, and calculating the traditional single volumetric harmonic field on a tetrahedral background mesh:
4. calculating the saddle point S₁ based on the traditional single volumetric harmonic field, and tracing along the gradient in the direction of energy increase up to the source 3D model surface mesh to obtain tracing domains r₁^{S}^{₁} and r₂^{S}^{₁}, as shown in FIG. 4;
5. taking the energy 1 of the domain r₁^{S}^{₁} and the energy 0 of the domain r₂^{S}^{₁}, as well as the energy 1 of the domain r₂^{S}^{₁} and the energy 0 of the domain r₁^{S}^{₁} as Dirichlet boundary conditions, calculating a double volumetric harmonic field H=[H₁, H₂] based on formula (5) and formula (6);
6. calculating an anisotropic scalar field based on the multiple volumetric harmonic field according to formula (9);
7. calculating sample energy g={0.2, 0.4, 0.6, 0.8} according to the inputted deformation times 4:
8. calculating the isosurfaces in the anisotropic scalar field according to the sample energy. and constructing deformation surfaces {M₁, M₂, M₃, M₄}, as shown in FIG. 6.

1. A topological preserving deformation method for a 3D model based on a multiple volumetric harmonic field, comprising the following steps:
(1) generating a tetrahedral discrete mesh of a diffeomorphism deformation space between a source model and an envelope model
(1.1) inputting a source 3D model and an envelope 3D model with the same topology as the source 3D model, and using a triangular surface mesh or a quadrilateral surface mesh;
(1.2) defining the deformation space of the 3D model as a space between the source 3D model and the envelope 3D model:
(1.3) discretizing the deformation space by using the tetrahedral mesh;
(1.4) tessellating the mesh of the deformation space according to model features: firstly, calculating a scalar field in the tetrahedral mesh by using a Laplace operator, and calculating the position of a saddle point in the scalar field; then, tessellating tetrahedral elements near the saddle point to improve the local mesh resolution; and finally, optimizing the tetrahedral mesh after local tessellation to improve the quality of mesh elements:
(2) constructing a multiple volumetric harmonic field
(2.1) defining the multiple volumetric harmonic field on a vertex of the tetrahedral mesh:
$$H ( {v}_{p} ) = [ {H}_{1} ( {v}_{p} ) , {H}_{2} ( {v}_{p} ) , … , {H}_{d} ( {v}_{p} ) ] , \qquad ( 1 )$$
where d is a multiple index of the multiple volumetric harmonic field, and Hᵢ(νₚ) is a scalar value obtained by an i-th multiple volumetric harmonic field acting on the vertex νₚ of the tetrahedral mesh, i=1, 2, . . . d;
(2.2) calculating the definition of a Laplace equation of the multiple volumetric harmonic field on the tetrahedral grid:
$$LG = 0 , \qquad ( 2 )$$
where L is a weight matrix for solving the Laplace equation, with an expression:
$${L}_{pq} = \{ \begin{matrix}{\sum }_{{v}_{k} ∈ N ( {v}_{p} )} w ( {e}_{pq} ) , & p = q ; \\ - w ( {e}_{pq} ) , & {v}_{q} ∈ N ( {v}_{p} ) ; \\ 0 , & other ;\end{matrix} \qquad ( 3 )$$
where e_{pg} is an edge on the tetrahedral mesh and has endpoints of νₚ and ν_{q} respectively: N(vₚ) is a neighbor region point set of νₚ; w(e_{pq}) is the edge weight of calculating the Laplace equation; and G is a multiple volumetric harmonic field matrix which has an expression:
$$G = [ \begin{matrix}{H}_{1} ( {v}_{1} ) & {H}_{2} ( {v}_{2} ) & … & {H}_{d} ( {v}_{1} ) \\ {H}_{1} ( {v}_{2} ) & {H}_{2} ( {v}_{2} ) & … & {H}_{d} ( {v}_{2} ) \\ ⋮ & ⋮ & ⋱ & ⋮ \\ {H}_{1} ( {v}_{n} ) & {H}_{2} ( {v}_{n} ) & … & {H}_{d} ( {v}_{n} )\end{matrix} ] , \qquad ( 4 )$$
(2.3) calculating the multiple volumetric harmonic field on the tetrahedral mesh:
defining multiple volumetric harmonic energy T(H) as:
$$T ( H ) = {\sum }_{{e}_{pq} ∈ E} w ( {e}_{pq} ) {( {‖ H ( {v}_{p} ) - H ( {v}_{q} ) ‖}_{∞} )}^{2} , \qquad ( 5 )$$
where E is an edge set on the tetrahedral mesh;
converting the calculation of the multiple volumetric harmonic field on the tetrahedral mesh into the optimization of the multiple volumetric harmonic energy T(H); when T(H) is minimized, H is the multiple volumetric harmonic field;
optimizing the multiple volumetric harmonic energy T(H) by an iteration method, with an iteration formula:
$$H ( {v}_{p} ) = \frac{{\sum }_{{v}_{q} ∈ N ( {v}_{p} )} w ( {e}_{pq} ) H ( {v}_{q} )}{{\sum }_{{v}_{q} ∈ N ( {v}_{p} )} w ( {e}_{pq} )} , \qquad ( 6 )$$
(2.4) constructing boundary conditions of the multiple volumetric harmonic field for inducing topological preserving deformation of the 3D model:
(2.4.1) constructing a single volumetric harmonic field for the deformation space:
(2.4.2) calculating a saddle point in the single volumetric harmonic field: the saddle point provides the position of topological change of the source 3D model when induced by the volumetric harmonic field and deformed to a target 3D model: if no saddle point exists in the single volumetric harmonic field, there is topological preserving deformation that can directly induce the source 3D model to the target 3D model based on isosurfaces:
(2.4.3) extracting boundary constraint points of the multiple volumetric harmonic field: detecting more than two feature points or feature domains on the model according to the saddle points along a harmonic field gradient;
(2.4.4) according to the extracted feature point pairs, using each feature point pair as the corresponding Dirichlet boundary condition to construct the volumetric harmonic field of the corresponding multiple indexes (the number of the feature point pairs);
(3) generating an anisotropic scalar field guided by the multiple volumetric harmonic field, specifically as follows:
(3.1) calculating anisotropic edge weight based on the multiple volumetric harmonic field:
$$\overline{w} ( {e}_{pq} ) = 1. / exp ( {‖ H ( {v}_{p} ) - H ( {v}_{q} ) ‖}_{2} * λ ) , \qquad ( 7 )$$
where λ is a parameter for controlling the influence degree of the multiple volumetric harmonic field on the edge weight:
(3.2) calculating the scalar fields based on the anisotropic edge weight:
$$\overline{L} F = 0 , \qquad ( 10 )$$
where F is the anisotropic scalar field acting on the tetrahedral mesh and is a weighted Laplace matrix, with an expression:
$${\overline{L}}_{pq} = \{ \begin{matrix}{\sum }_{{v}_{k} ∈ N ( {v}_{p} )} \overline{w} ( {e}_{pq} ) , & p = q ; \\ - \overline{w} ( {e}_{pq} ) , & {v}_{q} ∈ N ( {v}_{p} ) ; \\ 0 , & other ;\end{matrix} \qquad ( 8 )$$
(3.3) setting the Dirichlet boundary conditions:
$$F ( {v}_{k} ) = \{ \begin{matrix}γ , & {v}_{k} ∈ {M}_{source} \\ χ , & {v}_{k} ∈ {M}_{target}\end{matrix} ; \qquad ( 9 )$$
where y and X are constant scalars; and M_{source} and M_{target} are the source 3D model and the target 3D model respectively;
(4) topological preserving deformation of the 3D model based on the anisotropic scalar field
(4.1) extracting n parts of isosurfaces from the anisotropic scalar field, denoted as g={g₁, g₂, . . . , gₙ}; each isosurface is a state of a deformation process;
(4.2) starting from a point νₖ ∈M_{source} on the source model, tracing to n parts of isosurfaces along the gradient of the anisotropic scalar field to obtain n new vertexes {νₖ¹, νₖ², . . . , νₖⁿ} respectively;
(4.3) according to the obtained vertex νₖⁱ on each layer, generating n parts of topological preserving deformation models {M₁, M₂, . . . , Mₙ} by using M_{source} based vertex connection mode.
